(19) United States
(12) Patent Application Publication
(10) Pub. No.: US 2012/0251821 A1
(43) Pub. Date: Oct. 4, 2012

(54) PRESSURE-SENSITIVE ADHESIVE LAYER FOR OPTICAL FILM, PRESSURE-SENSITIVE ADHESIVE OPTICAL FILM, METHOD FOR MANUFACTURING THEREOF, AND IMAGE DISPLAY

(75) Inventors: Toshitsugu Hosokawa, Ibaraki-shi (JP); Kunihiro Inui, Ibaraki-shi (JP); Takaaki Ishii, Ibaraki-shi (JP); Masayuki Satake, Ibaraki-shi (JP); Kenichi Okada, Ibaraki-shi (JP); Toshitaka Takahashi, Ibaraki-shi (JP)

(73) Assignee: NITTO DENKO CORPORATION, Ibaraki-shi, Osaka (JP)

(21) Appl. No.: 13/513,711

(22) PCT Filed: Oct. 28, 2010
(86) PCT No.: PCT/JP2010/069145

§ 371 Date: Jun. 4, 2012

(30) Foreign Application Priority Data
Dec. 9, 2009 (JP) 2009-279874

(51) Int. Cl. B05D 5/06; B32B 27/00

(52) U.S. Cl. 428/355 AC; 427/162

(57) ABSTRACT

A pressure-sensitive adhesive layer for an optical film of the invention, which is formed by applying an aqueous dispersion pressure-sensitive adhesive including an aqueous dispersion containing at least a base polymer dispersed in water, and then drying the applied aqueous dispersion pressure-sensitive adhesive, has a content of residual monomer in the pressure-sensitive adhesive layer is 5 to 100 ppm per 1 g of the solid of the pressure-sensitive adhesive layer. The pressure-sensitive adhesive layer for an optical film has high durability so that foaming and peeling can be suppressed even under high temperature or high humidity environment.

### TECHNICAL FIELD

The invention relates to a pressure-sensitive adhesive layer for an optical film formed from an aqueous dispersion pressure-sensitive adhesive. The invention also relates to a pressure-sensitive adhesive optical film including an optical film and the pressure-sensitive adhesive layer provided on the optical film and to a method for manufacturing thereof. The invention further relates to an image display, such as a liquid crystal display device, an organic electroluminescence (EL) display device, or a plasma display panel (PDP), which is produced using the pressure-sensitive adhesive optical film. Examples of the optical film that may be used include a polarizing plate, a retardation plate, an optical compensation film, a brightness enhancement film, and a laminate of any combination thereof.

### BACKGROUND ART

A liquid crystal display or the like has an image-forming mechanism in which polarizing elements are essentially placed on both sides of the liquid crystal cell, and generally, polarizing plates are attached as the polarizing elements. Besides polarizing plates, various optical elements for improving display quality have been used in a liquid crystal panel. For example, there are used a retardation plate for preventing discoloration, a viewing angle expansion film for improving the viewing angle of the liquid crystal display, and a brightness enhancement film for enhancing the contrast of the display. These films are generically called optical films.

When such optical films are attached to a liquid crystal cell, a pressure-sensitive adhesive is generally used. In the process of bonding an optical film and a liquid crystal cell or optical films together, a pressure-sensitive adhesive is generally used to bond the materials together so that optical loss can be reduced. In such a case, a pressure-sensitive adhesive optical film including an optical film and a pressure-sensitive adhesive layer previously formed on one side of the optical film from a pressure-sensitive adhesive composition is generally used, because it has some advantages such as no need for a drying process to fix the optical film.

Since the optical film used in the pressure-sensitive adhesive optical film can easily shrink or expand under heating or humidifying conditions, the pressure-sensitive adhesive optical film can easily separate or peel after it is bonded to a liquid crystal cell. Therefore, the pressure-sensitive adhesive layer is required to have durability against heating, humidification, and so on. The pressure-sensitive adhesive layer is also required to have such workability that after formed on an optical film, the pressure-sensitive adhesive layer can be worked without adhesive staining or missing.

Conventionally, organic solvent-containing pressure-sensitive adhesives have generally been used in forming pressure-sensitive adhesive layers for the pressure-sensitive adhesive optical film, because they have good durability in a heated environment or a heated and humidified environment. In recent years, however, solvent-free pressure-sensitive adhesives, which are produced with no organic solvent, have been developed aggressively in view of a reduction in global environmental loading or an improvement in process stability.

Concerning solvent-free pressure-sensitive adhesives, there is proposed a method of forming a pressure-sensitive adhesive layer by applying ultraviolet light to a pressure-sensitive adhesive composition containing a high-molecular-weight polymer and a predetermined amount of a monomer so that the composition can be photo-polymerized to such an extent that the residual monomer content reaches a predetermined level or less (Patent Document 1). Concerning solvent-free pressure-sensitive adhesives, there are also proposed aqueous dispersion pressure-sensitive adhesives which contain a pressure-sensitive adhesive component dispersed in water used as a dispersion medium. Concerning aqueous dispersion pressure-sensitive adhesives, for example, there are proposed aqueous dispersion acryl-based pressure-sensitive adhesives produced with a phosphate group-containing monomer in view of moisture resistance (Patent Document 2). Concerning aqueous dispersion pressure-sensitive adhesives, there is also proposed a method that includes adding a redox initiator in the production of a water-dispersible acryl-based polymer so that an aqueous dispersion pressure-sensitive adhesive with a reduced residual monomer content can be produced (Patent Document 3). It has been hoped that aqueous dispersion pressure-sensitive adhesives will be put to practical use, particularly in view of productivity, appearance, and economic aspects such as no need to use secondary materials such as covers and separators.

### PRIOR ART DOCUMENTS

### Patent Documents

Patent Document 1: JP-A No. 2002-241707

Patent Document 2: JP-A No. 2007-186661

Patent Document 3: JP-A No. 2006-169293

### SUMMARY OF THE INVENTION

### Problems to be Solved by the Invention

Unfortunately, pressure-sensitive adhesive optical films whose pressure-sensitive adhesive layer is formed using an aqueous dispersion pressure-sensitive adhesive have a durability problem in that they can cause foaming or peeling in a severe environment such as a heated environment or a heated and humidified environment. Patent Document 3 discloses reducing the residual monomer content of an aqueous dispersion pressure-sensitive adhesive for use in forming a pressure-sensitive adhesive layer. Unfortunately, only when the residual monomer content of an aqueous dispersion pressure-sensitive adhesive is simply reduced, it is difficult to obtain a pressure-sensitive adhesive optical film with satisfactory durability.

An object of the invention is to provide a pressure-sensitive adhesive layer for an optical film that is applicable to an optical film, is formed from an aqueous dispersion pressure-sensitive adhesive, and has high durability so that foaming and peeling can be suppressed even under high temperature or high humidity environment.

Another object of the invention is to provide a pressure-sensitive adhesive optical film including an optical film and the pressure-sensitive adhesive layer for an optical film placed on at least one side of the optical film and to a method for manufacturing thereof. A further object of the invention is to provide an image display including the pressure-sensitive adhesive optical film.

### MEANS FOR SOLVING THE PROBLEMS

As a result of earnest studies to solve the above problems, the inventors have accomplished the invention based on the finding that the pressure-sensitive adhesive layer for an optical film described below can solve the problems.

The invention relates to a pressure-sensitive adhesive layer for an optical film, which is formed by applying an aqueous dispersion pressure-sensitive adhesive including an aqueous dispersion containing at least a base polymer dispersed in water, and then drying the applied aqueous dispersion pressure-sensitive adhesive, wherein

a content of residual monomer in the pressure-sensitive adhesive layer is 5 to 100 ppm per 1 g of the solid of the pressure-sensitive adhesive layer.

In the pressure-sensitive adhesive layer for an optical film, the base polymer in the aqueous dispersion pressure-sensitive adhesive is preferably a (meth)acryl-based polymer. The base polymer is also preferably a (meth)acryl-based polymer obtained by emulsion polymerization.

The invention also relates to a pressure-sensitive adhesive optical film, including an optical film and the pressure-sensitive adhesive layer for an optical film placed on at least one side of the optical film.

The invention also relates to a method for manufacturing the pressure-sensitive adhesive optical film, including the steps of:

(1) applying an aqueous dispersion pressure-sensitive adhesive to one or both sides of an optical film, wherein the aqueous dispersion pressure-sensitive adhesive comprises an aqueous dispersion containing at least a base polymer dispersed in water and has a residual monomer content of 1,500 to 25,000 ppm per 1 g of the solid of the aqueous dispersion; and

(2A) drying the applied aqueous dispersion pressure-sensitive adhesive at a drying temperature of 80 to 170° C. so that a pressure-sensitive adhesive layer can be formed having a residual monomer content of 5 to 100 ppm per 1 g of the solid of the pressure-sensitive adhesive layer.

The invention also relates to a method for manufacturing the pressure-sensitive adhesive optical film, including the steps of:

(1) applying an aqueous dispersion pressure-sensitive adhesive to one or both sides of a release film, wherein the aqueous dispersion pressure-sensitive adhesive comprises an aqueous dispersion containing at least a base polymer dispersed in water and has a residual monomer content of 1,500 to 25,000 ppm per 1 g of the solid of the aqueous dispersion;

(2B) drying the applied aqueous dispersion pressure-sensitive adhesive at a drying temperature of 80 to 170° C. so that a pressure-sensitive adhesive layer can be formed having a residual monomer content of 5 to 100 ppm per 1 g of the solid of the pressure-sensitive adhesive layer; and

(3) bonding the pressure-sensitive adhesive layer, which is formed on the release film, to an optical film.

The invention also relates to an image display including at least one piece of the pressure-sensitive adhesive optical film.

### EFFECTS OF THE INVENTION

The pressure-sensitive adhesive layer for an optical film of the invention, which is made from an aqueous dispersion pressure-sensitive adhesive, has a controlled residual monomer content in the specified range (5-100 ppm) and therefore possesses sufficiently high durability to be suitable for use in a pressure-sensitive adhesive optical film. The pressure-sensitive adhesive layer for an optical film of the invention also has a good appearance.

The pressure-sensitive adhesive optical film of the invention may be obtained by a process including applying an aqueous dispersion pressure-sensitive adhesive whose residual monomer content has been controlled within the specified range (1,500-25,000 ppm) before the application and drying it under the specified conditions (80-170° C.) to form a pressure-sensitive adhesive layer. The pressure-sensitive adhesive optical film obtained in this manner also has high durability. Also in this method of manufacturing a pressure-sensitive adhesive optical film, the aqueous dispersion pressure-sensitive adhesive has good storage stability and is successfully prevented from being spoiled, because it contains a specific amount or more of a residual monomer or monomers before the application.

### EMBODIMENTS FOR CARRYING OUT THE INVENTION

The pressure-sensitive adhesive layer for an optical film of the invention is a product formed by a process including applying an aqueous dispersion pressure-sensitive adhesive and then drying it, and the pressure-sensitive adhesive layer has a residual monomer content controlled within the range of 5 to 100 ppm.

If the residual monomer content of the pressure-sensitive adhesive layer is more than 100 ppm, foaming by heating or water absorption by humidification will be accelerated by the direct influence of the residual monomer or monomers, so that a problem with durability, such as foaming or peeling will occur on the pressure-sensitive adhesive layer. Also, if the residual monomer content is high, the pressure-sensitive adhesive layer will have a low coating strength, so that a problem such as foaming or peeling will be more likely to occur. On the other hand, if the residual monomer content of the pressure-sensitive adhesive layer is less than 5 ppm, a long thermal history will be necessary for the drying step in the process of forming the pressure-sensitive adhesive layer, so that the resulting pressure-sensitive adhesive layer will be more likely to be damaged. Although the reason is not clear, a specific small amount of the residual monomer or monomers effectively work against peeling and other problems. The residual monomer content of the pressure-sensitive adhesive layer is preferably from 5 to 50 ppm, in particular, preferably from 5 to 30 ppm.

The residual monomer content of the pressure-sensitive adhesive layer has been quantified by gas chromatography as described in the section EXAMPLES. When a high-boiling-point monomer (with a boiling point of 250° C. or more) is present, liquid chromatography has been used in combination with gas chromatography to quantify the residual monomer content. The sum of the measurements obtained by gas chromatography and liquid chromatography corresponds to the residual monomer content.

The aqueous dispersion pressure-sensitive adhesive is an aqueous dispersion containing at least a base polymer dispersed in water. While the aqueous dispersion to be used generally contains a base polymer dispersed in the presence of a surfactant, an aqueous dispersion containing a self-dispersible base polymer dispersed by itself in water may also be used.

The base polymer in the aqueous dispersion may be a product obtained by emulsion polymerization of a monomer or monomers in the presence of an emulsifying agent or obtained by dispersion polymerization of a monomer or monomers in the presence of a surfactant.

The aqueous dispersion may also be produced by dispersing and emulsifying a base polymer in water in the presence of an emulsifying agent, in which the base polymer has been produced separately. The emulsifying method may be a method including uniformly dispersing and emulsifying a polymer and an emulsifying agent, which may or may not have previously been melted by heating, with water using a mixer such as a pressure kneader, a colloid mill, or a high-speed stirring shaft, under high shearing, and then cooling the mixture in such a manner that the dispersed particles do not fuse or aggregate, so that a desired aqueous dispersion is obtained (high-pressure emulsification method); or a method including previously dissolving a polymer in an organic solvent such as benzene, toluene, or ethyl acetate, then adding the emulsifying agent and water to the solution, uniformly dispersing and emulsifying the mixture typically using a high-speed homogenizer under high shearing, and then removing the organic solvent by a heat treatment under reduced pressure or other methods to form a desired aqueous dispersion (solvent dissolution method).

The aqueous dispersion pressure-sensitive adhesive to be used may be of any type such as a rubber-based pressure-sensitive adhesive, an acryl-based pressure-sensitive adhesive, a silicone-based pressure-sensitive adhesive, a polyurethane-based pressure-sensitive adhesive, a vinyl alkyl ether-based pressure-sensitive adhesive, a polyvinyl alcohol-based pressure-sensitive adhesive, a polyvinylpyrrolidone-based pressure-sensitive adhesive, a polyacrylamide-based pressure-sensitive adhesive, a cellulose-based pressure-sensitive adhesive, a polyester-based pressure-sensitive adhesive, or a fluoride pressure-sensitive adhesive. The pressure-sensitive adhesive base polymer and the dispersing means are selected depending on the type of the pressure-sensitive adhesive.

Among the pressure-sensitive adhesives, an aqueous dispersion acryl-based pressure-sensitive adhesive is preferably used in an embodiment of the invention, because it has a high level of optical transparency and weather resistance or heat resistance and exhibits appropriate wettability and pressure-sensitive adhesive properties such as appropriate cohesiveness and tackiness.

An aqueous dispersion acryl-based pressure-sensitive adhesive includes a (meth)acryl-based polymer as a base polymer, for example, which can be obtained in the form of a copolymer emulsion by emulsion polymerization of monomer components, which contain alkyl (meth)acrylate as a main component, in the presence of an emulsifying agent and a radical polymerization initiator. The term “alkyl (meth)acrylate” refers to alkyl acrylate and/or alkyl methacrylate, and “(meth)” is used in the same meaning in the description.

For example, the alkyl (meth)acrylate used to form the main skeleton of the (meth)acryl-based polymer may have a straight or branched chain alkyl group of 1 to 20 carbon atoms. For example, the alkyl group may be methyl, ethyl, propyl, isopropyl, n-butyl, isobutyl, sec-butyl, tert-butyl, pentyl, neopentyl, isoamyl, hexyl, heptyl, 2-ethylhexyl, isooctyl, nonyl, isononyl, decyl, isodecyl, dodecyl, tridecyl, tetradecyl, pentadecyl, hexadecyl, heptadecyl, octadecyl, nonadecyl, or eicosyl. These may be used alone or in any combination. The average carbon number of such alkyl groups is preferably from 3 to 9. In particular, a monomer with a boiling point higher than that of water, such as butyl acrylate is preferably used as the alkyl (meth)acrylate in an embodiment of the invention.

Besides the alkyl (meth)acrylate, one or more copolymerizable monomers having an unsaturated double bond-containing polymerizable functional group such as a (meth)acryloyl group or a vinyl group may be incorporated into the (meth)acryl-based polymer by copolymerization for purposes such as stabilization of the aqueous dispersion, improvement in the adhesion of the pressure-sensitive adhesive layer to a base material such as an optical film, and improvement in the initial tackiness to adherends.

Examples of the copolymerizable monomer include, but are not limited to, carboxyl group-containing monomers such as (meth)acrylic acid, itaconic acid, maleic acid, fumaric acid, crotonic acid, carboxyethyl acrylate, and carboxypentyl acrylate; acid anhydride group-containing monomers such as maleic anhydride and itaconic anhydride; alicyclic hydrocarbon esters of (meth)acrylic acid, such as cyclohexyl (meth)acrylate, bornyl (meth)acrylate, and isobornyl (meth)acrylate; aryl (meth)acrylate such as phenyl (meth)acrylate; vinyl esters such as vinyl acetate and vinyl propionate; styrene monomers such as styrene; epoxy group-containing monomers such as glycidyl (meth)acrylate and methylglycidyl (meth)acrylate; hydroxyl group-containing monomers such as 2-hydroxyethyl acrylate and 2-hydroxypropyl acrylate; nitrogen atom-containing monomers such as (meth)acrylamide, N,N-dimethyl(meth)acrylamide, N,N-diethyl(meth)acrylamide, N-isopropyl(meth)acrylamide, N-butyl(meth)acrylamide, N-methylol(meth)acrylamide, N-methylolpropane(meth)acrylamide, (meth) acryloylmorpholine, aminoethyl (meth) acrylate, N,N-dimethylaminoethyl (meth) acrylate, and tert-butylaminoethyl (meth)acrylate; alkoxy group-containing monomers such as methoxyethyl (meth)acrylate and ethoxyethyl (meth)acrylate; cyano group-containing monomers such as acrylonitrile and methacrylonitrile; functional monomers such as 2-methacryloyloxyethyl isocyanate; olefin monomers such as ethylene, propylene, isoprene, butadiene, and isobutylene; vinyl ether monomers such as vinyl ether; halogen atom-containing monomers such as vinyl chloride; and other monomers including vinyl group-containing heterocyclic compounds such as N-vinylpyrrolidone, N-(1-methylvinyl)pyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, and N-vinylmorpholine, and N-vinylcarboxylic acid amides.

Examples of the copolymerizable monomer also include maleimide monomers such as N-cyclohexylmaleimide, N-isopropylmaleimide, N-laurylmaleimide, and N-phenylmaleimide; itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide; succinimide monomers such as N-(meth)acryloyloxymethylenesuccinimide, N-(meth)acryloyl-6-oxyhexamethylenesuccinimide, and N-(meth)acryloyl-8-oxyoctamethylenesuccinimide; and sulfonic acid group-containing monomers such as styrenesulfonic acid, allylsulfonic acid, 2-(meth)acrylamido-2-methylpropanesulfonic acid, (meth)acrylamidopropanesulfonic acid, sulfopropyl (meth)acrylate, and (meth)acryloyloxynaphthalenesulfonic acid.

The copolymerizable monomer may also be a phosphate group-containing monomer. For example, the phosphate group-containing monomer may be a phosphate group-containing monomer represented by formula (1) below or a salt thereof.

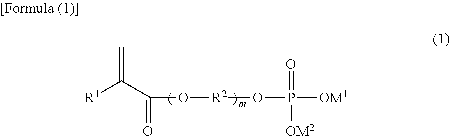

In formula (1), R¹ represents a hydrogen atom or a methyl group, R² represents an alkylene group of 1 to 4 carbon atoms, m represents an integer of 2 or more, and M¹ and M² each independently represent a hydrogen atom or a cation.

In formula (1), m is 2 or more, preferably 4 or more, generally 40 or less, and m represents the degree of polymerization of the oxyalkylene groups. The polyoxyalkylene group may be a polyoxyethylene group or a polyoxypropylene group, and these polyoxyalkylene groups may comprise random, block, or graft units. The cation of the salt of the phosphate group is typically, but not limited to, an inorganic cation such as an alkali metal such as sodium or potassium or an alkaline-earth metal such as calcium or magnesium, or an organic cation such as a quaternary amine.

Examples of the copolymerizable monomer also include glycol acrylate monomers such as polyethylene glycol (meth)acrylate, polypropylene glycol (meth)acrylate, methoxyethylene glycol (meth)acrylate, and methoxypolypropylene glycol (meth)acrylate; and other monomers such as acrylic ester monomers containing a heterocyclic ring or a halogen atom, such as tetrahydrofurfuryl (meth)acrylate and fluoro(meth)acrylate.

The copolymerizable monomer may also be an unsaturated silicone monomer. Examples of the unsaturated silicone monomer include a silicone (meth)acrylate monomer and a vinyl silicone monomer. For example, silicone (meth)acrylate monomers include (meth)acryloyloxyalkyl-trialkoxysilanes such as (meth) acryloyloxymethyl-trimethoxysilane, (meth) acryloyloxymethyl-triethoxysilane, 2-(meth)acryloyloxyethyl-trimethoxysilane, 2-(meth)acryloyloxyethyl-triethoxysilane, 3-(meth) acryloyloxypropyl-trimethoxysilane, 3-(meth)acryloyloxypropyl-triethoxysilane, 3-(meth)acryloyloxypropyl-tripropoxysilane, 3-(meth)acryloyloxypropyl-triisopropoxysilane, and 3-(meth)acryloyloxypropyl-tributoxysilane; (meth) acryloyloxyalkyl-alkyldialkoxysilanes such as (meth)acryloyloxymethyl-methyldimethoxysilane, (meth) acryloyloxymethyl-methyldiethoxysilane, 2-(meth)acryloyloxyethyl-methyldimethoxysilane, 2-(meth)acryloyloxyethyl-methyldiethoxysilane, 3-(meth)acryloyloxypropyl-methyldimethoxysilane, 3-(meth)acryloyloxypropyl-methyldiethoxysilane, 3-(meth)acryloyloxypropyl-methyldipropoxysilane, 3-(meth)acryloyloxypropyl-methyldiisopropoxysilane, 3-(meth)acryloyloxypropyl-methyldibutoxysilane, 3-(meth)acryloyloxypropyl-ethyldimethoxysilane, 3-(meth)acryloyloxypropyl-ethyldiethoxysilane, 3-(meth)acryloyloxypropyl-ethyldipropoxysilane, 3-(meth)acryloyloxypropyl-ethyldiisopropoxysilane, 3-(meth)acryloyloxypropyl-ethyldibutoxysilane, 3-(meth)acryloyloxypropyl-propyldimethoxysilane, and 3-(meth)acryloyloxypropyl-propyldiethoxysilane; and (meth) acryloyloxyalkyl-dialkyl (mono)alkoxysilanes corresponding to these monomers. For example, vinyl silicone monomers include vinyltrialkoxysilanes such as vinyltrimethoxysilane, vinyltriethoxysilane, vinyltripropoxysilane, vinyltriisopropoxysilane, and vinyltributoxysilane, and vinylalkyldialkoxysilanes and vinyldialkylalkoxysilanes corresponding thereto; vinylalkyltrialkoxysilanes such as vinylmethyltrimethoxysilane, vinylmethyltriethoxysilane, β-vinylethyltrimethoxysilane, β-vinylethyltriethoxysilane, Υ-vinylpropyltrimethoxysilane, Υ-vinylpropyltriethoxysilane, Υ-vinylpropyltripropoxysilane, . Υ-vinylpropyltriisopropoxysilane, and Υ-vinylpropyltributoxysilane, and (vinylalkyl)alkyldialkoxysilanes and (vinylalkyl)dialkyl(mono)alkoxysilanes corresponding thereto.

A polyfunctional monomer may also be used as the copolymerizable monomer for a purpose such as control of the gel fraction of the aqueous dispersion pressure-sensitive adhesive. The polyfunctional monomer may be a compound having two or more unsaturated double bonds such as those in (meth)acryloyl groups or vinyl groups. Examples that may also be used include (meth)acrylate esters of polyhydric alcohols, such as (mono or poly)alkylene glycol di(meth)acrylates including (mono or polyethylene glycol di(meth)acrylates such as ethylene glycol di(meth)acrylate, diethylene glycol di(meth)acrylate, triethylene glycol di(meth)acrylate, trimethylolpropane tri(meth)acrylate, and tetraethylene glycol di(meth)acrylate, (mono or poly)propylene glycol di(meth)acrylate such as propylene glycol di(meth)acrylate, neopentyl glycol di(meth)acrylate, 1,6-hexanediol di(meth)acrylate, pentaerythritol di(meth)acrylate, trimethylolpropane tri(meth)acrylate, pentaerythritol tri(meth)acrylate, and dipentaerythritol hexa(meth)acrylate; polyfunctional vinyl compounds such as divinylbenzene; and compounds having a reactive unsaturated double bond, such as allyl (meth)acrylate and vinyl (meth)acrylate. The polyfunctional monomer may also be a compound having a polyester, epoxy or urethane skeleton to which two or more unsaturated double bonds are added in the form of functional groups such as (meth)acryloyl groups or vinyl groups in the same manner as the monomer component, such as polyester (meth)acrylate, epoxy (meth)acrylate, or urethane (meth)acrylate.

Among these copolymerizable monomers, the carboxyl group-containing monomers such as acrylic acid, the phosphate group-containing monomers or the unsaturated silicone monomers are preferably used in view of stabilization of the aqueous dispersion (such as the emulsion) or the like and reliable adhesion of the pressure-sensitive adhesive layer, which is formed from the aqueous dispersion pressure-sensitive adhesive containing the aqueous dispersion, to a glass panel as an adherend.

The (meth)acryl-based polymer may include alkyl (meth)acrylate as a main component, and the content of the alkyl (meth)acrylate component may be 50% by weight or more, preferably 60% by weight or more, more preferably 70% by weight or more, based on the total amount of all monomer components. The upper limit of the content is typically, but not limited to, 100% by weight, preferably 99% by weight, more preferably 98% by weight. If the content of the alkyl (meth)acrylate component is less than 50% by weight, the adhesive properties of the pressure-sensitive adhesive layer, such as the adhesive strength, may be degraded in some cases.

The content of the copolymerizable monomer is typically less than 50% by weight, preferably less than 40% by weight, more preferably less than 30% by weight, based on the total amount of all monomer components. The content of the copolymerizable monomer may be appropriately selected depending on the type of each copolymerizable monomer. Based on the total amount of all monomers, for example, the content of a carboxyl group-containing monomer as the copolymerizable monomer is preferably from 0.1 to 6% by weight, and the content of a phosphate group-containing monomer as the copolymerizable monomer is preferably from 0.5 to 5% by weight. The content of an unsaturated silicone monomer is preferably from 0.005 to 0.2% by weight.

Emulsion polymerization of the monomer components may be performed by a conventional method including emulsifying the monomer components in water and then subjecting the emulsion to emulsion polymerization. This method prepares an aqueous dispersion containing a (meth)acryl-based polymer as a base polymer. In the emulsion polymerization, for example, the monomer components, an emulsifying agent, and a radical polymerization initiator, and optionally a chain transfer agent or the like are mixed in water as appropriate. More specifically, for example, a known emulsion polymerization method may be employed, such as a batch mixing method (batch polymerization method), a monomer dropping method, or a monomer emulsion dropping method. In a monomer dropping method, continuous dropping or divided dropping is appropriately selected. These methods may be appropriately combined. While reaction conditions and so on may be appropriately selected, for example, the polymerization temperature is preferably from about 0 to about 150° C., and the polymerization time is preferably from about 2 to about 15 hours.

The emulsifying agent to be used may be, but not limited to, any of various emulsifying agents commonly used in emulsion polymerization. Examples include anionic emulsifying agents such as sodium lauryl sulfate, ammonium lauryl sulfate, sodium dodecylbenzenesulfonate, sodium polyoxyethylene lauryl sulfate, sodium polyoxyethylene alkyl ether sulfate, ammonium polyoxyethylene alkyl phenyl ether sulfate, sodium polyoxyethylene alkyl phenyl ether sulfate, and sodium polyoxyethylene alkyl sulfosuccinate; and nonionic emulsifying agents such as polyoxyethylene alkyl ether, polyoxyethylene alkyl phenyl ether, polyoxyethylene fatty acid ester, and polyoxyethylene-polyoxypropylene block polymers. Examples also include radically-polymerizable emulsifying agents produced by introducing a radically-polymerizable functional group (radically-reactive group) such as a propenyl group or an allyl ether group into the above anionic or nonionic emulsifying agents. These emulsifying agents may be appropriately used alone or in combination of two or more. Among these emulsifying agents, radically-polymerizable emulsifying agents having a radically-polymerizable functional group are preferably used in view of the stability of the aqueous dispersion (emulsion) or the durability of the pressure-sensitive adhesive layer.

The content of the emulsifying agent is typically from about 0.1 to about 5 parts by weight, preferably from 0.4 to 3 parts by weight, based on 100 parts by weight of the monomer components including the alkyl (meth)acrylate as a main component. Setting the emulsifying agent content in this range makes it possible to improve not only water resistance and adhesive properties but also other properties such as polymerization stability and mechanical stability.

The radical polymerization initiator may be, but not limited to, any known radical polymerization initiator commonly used in emulsion polymerization. Examples include azo initiators such as 2,2′-azobisisobutylonitrile, 2,2′-azobis(2-methylpropionamidine)disulfate, 2,2′-azobis(2-methylpropionamidine)dihydrochloride, 2,2′-azobis(2-amidinopropane)dihydrochloride, and 2,2′-azobis[2-(2-imidazoline-2-yl)propane]dihydrochloride; persulfate initiators such as potassium persulfate and ammonium persulfate; peroxide initiators such as benzoyl peroxide, tert-butyl hydroperoxide, and hydrogen peroxide; substituted ethane initiators such as phenyl-substituted ethane; and carbonyl initiators such as aromatic carbonyl compounds. These polymerization initiators may be appropriately used alone or in any combination. The content of the radical polymerization initiator is typically from about 0.02 to about 0.5 parts by weight, preferably from 0.08 to 0.3 parts by weight, based on 100 parts by weight of the monomer components, while it is appropriately selected. If it is less than 0.02 parts by weight, the radical polymerization initiator may be less effective. If it is more than 0.5 parts by weight, the water-dispersible (meth)acryl-based polymer may have a reduced molecular weight, so that the aqueous dispersion pressure-sensitive adhesive may have reduced durability.

A chain transfer agent is optionally used to control the molecular weight of the water-dispersible (meth)acryl-based polymer. In general, chain transfer agents commonly used in emulsion polymerization are used. Examples include 1-dodecanthiol, mercaptoacetic acid, 2-mercaptoethanol, 2-ethylhexyl thioglycolate, 2,3-dimercapto-1-propanol, mercaptopropionic acid esters, and other mercaptans. These chain transfer agents may be appropriately used alone or in any combination. For example, the content of the chain transfer agent is from 0.001 to 0.3 parts by weight based on 100 parts by weight of the monomer components.

According to the emulsion polymerization described above, the water-dispersible (meth)acryl-based polymer can be prepared in the form of an aqueous dispersion (emulsion). The average particle size of such a water-dispersible (meth)acryl-based polymer is typically controlled in the range of 0.05 to 3 μm, preferably in the range of 0.05 to 1 μm. If the average particle size is less than 0.05 μm, the aqueous dispersion pressure-sensitive adhesive may have increased viscosity, and if it is more than 1 μm, adhesiveness between particles may decrease so that cohesive strength may decrease.

When the (meth)acryl-based polymer in the aqueous dispersion contains a carboxyl group-containing monomer component or the like for maintaining the stability of the aqueous dispersion, the carboxyl group-containing monomer component or the like should preferably be neutralized. For example, the neutralization can be performed using ammonia, an alkali metal hydroxide, or the like.

In general, the water-dispersible (meth)acryl-based polymer according to the invention preferably has a weight average molecular weight of 1,000,000 or more. In particular, the weight average molecular weight is preferably from 1,000,000 to 4,000,000 in view of heat resistance or moisture resistance. A weight average molecular weight of less than 1,000,000 is not preferred, because with such a molecular weight, heat resistance or moisture resistance may decrease. The pressure-sensitive adhesive obtained by the emulsion polymerization is preferred because the polymerization mechanism can produce very high molecular weight. It should be noted, however, that the pressure-sensitive adhesive obtained by the emulsion polymerization generally has a high gel content and cannot be subjected to GPC (gel permeation chromatography) measurement, which means that it is often difficult to identify the molecular weight by actual measurement.

In an embodiment of the invention, the aqueous dispersion pressure-sensitive adhesive may also contain a crosslinking agent in addition to the base polymer. The crosslinking agent for use in the aqueous dispersion acryl-based pressure-sensitive adhesive may be one commonly used, such as an isocyanate crosslinking agent, an epoxy crosslinking agent, an oxazoline crosslinking agent, an aziridine crosslinking agent, a carbodiimide crosslinking agent, or a metal chelate crosslinking agent. When a functional group-containing monomer is used, these crosslinking agents have the effect of reacting with the functional group incorporated in the (meth)acryl-based polymer to form crosslinkage.

While the content ratio between the base polymer and the crosslinking agent is not restricted, about 10 parts by weight or less (solid basis) of the crosslinking agent is generally added to 100 parts by weight (solid basis) of the base polymer. The content of the crosslinking agent is preferably from 0.001 to 10 parts by weight, more preferably from 0.01 to 5 parts by weight.

If necessary, the aqueous dispersion pressure-sensitive adhesive of the invention may further appropriately contain any of various additives such as viscosity adjusting agent, releasing adjusting agent, tackifiers, plasticizers, softener, fillers including glass fibers, glass beads, metal power, or any other inorganic powder, pigments, colorants(pigments, dyes or the likes), pH adjusting agent(acid or base), antioxidants, ultraviolet ray absorbing agents, and silane coupling agents, without departing from the objects of the invention. The aqueous dispersion pressure-sensitive adhesive may also contain fine particles to form a light-diffusing pressure-sensitive adhesive layer. These additives may also be added in the form of dispersion.

The pressure-sensitive adhesive layer for an optical film of the invention is formed from the aqueous dispersion pressure-sensitive adhesive. The pressure-sensitive adhesive layer can be formed by a process including applying the aqueous dispersion pressure-sensitive adhesive to a backing substrate (an optical film or a release film) and then drying it. The pressure-sensitive adhesive for an optical film of the invention is the pressure-sensitive adhesive layer formed by such a process, in which the content of remaining monomers should be controlled to be from 5 to 100 ppm.

The pressure-sensitive adhesive optical film of the invention includes an optical film and the pressure-sensitive adhesive layer placed on one or both sides of the optical film. For example, the pressure-sensitive adhesive optical film of the invention may be manufactured by

a process (A) including the steps of:

(1) applying an aqueous dispersion pressure-sensitive adhesive to one or both sides of an optical film, wherein the aqueous dispersion pressure-sensitive adhesive includes an aqueous dispersion containing at least a base polymer dispersed in water and has a residual monomer content of 1,500 to 25,000 ppm per 1 g of the solid of the aqueous dispersion; and

(2A) drying the applied aqueous dispersion pressure-sensitive adhesive at a drying temperature of 80 to 170° C. so that a pressure-sensitive adhesive layer can be formed having a residual monomer content of 5 to 100 ppm per 1 g of the solid of the pressure-sensitive adhesive layer, or by

a process (B) including the steps of:

(1) applying an aqueous dispersion pressure-sensitive adhesive to one or both sides of a release film, wherein the aqueous dispersion pressure-sensitive adhesive includes an aqueous dispersion containing at least a base polymer dispersed in water and has a residual monomer content of 1,500 to 25,000 ppm per 1 g of the solid of the aqueous dispersion;

(2B) drying the applied aqueous dispersion pressure-sensitive adhesive at a drying temperature of 80 to 170° C. so that a pressure-sensitive adhesive layer can be formed having a residual monomer content of 5 to 100 ppm per 1 g of the solid of the pressure-sensitive adhesive layer; and

(3) bonding the pressure-sensitive adhesive layer, which is formed on the release film, to an optical film.

In the applying step (1), the residual monomer content of the aqueous dispersion pressure-sensitive adhesive is preferably controlled to a specific content. When the residual monomer content of the aqueous dispersion pressure-sensitive adhesive used in the applying step (1) is controlled within the above range, reliable film formability can be provided during the drying, so that a highly-uniform, high-strength coating can be formed, which makes it possible to obtain a pressure-sensitive adhesive layer with high durability. Although it is not clear why a monomer or monomers remaining in the aqueous dispersion pressure-sensitive adhesive (coating liquid) are advantageously effective, it is considered that in the stage of removing water by drying in the step (2A) or (2B) for forming a pressure-sensitive adhesive layer, a monomer or monomers less volatile than water may be effective in accelerating the formation of the aqueous dispersion pressure-sensitive adhesive coating. If the residual monomer content of the aqueous dispersion pressure-sensitive adhesive is less than 1,500 ppm, insufficient film formability will be provided, which is not preferred in view of durability. On the other hand, if the residual monomer content is more than 25,000 ppm, it will be difficult to reduce the residual monomer content of the pressure-sensitive adhesive layer to 100 ppm or less by drying in the step (2A) or (2B) for forming the pressure-sensitive adhesive layer.

Keeping the residual monomer content of the aqueous dispersion pressure-sensitive adhesive at the specified level or higher, for use in the applying step (1), is also preferred in terms of preventing spoilage of the aqueous dispersion pressure-sensitive adhesive during storage. The aqueous dispersion pressure-sensitive adhesive with a low residual monomer content may be more likely to be spoiled during storage, and a pressure-sensitive adhesive optical film having a pressure-sensitive adhesive layer formed by applying such an adhesive may have a degraded appearance. Such spoilage is recognized as a unique problem with aqueous dispersions (emulsions), which is considered to be caused by contamination with microorganisms or bacteria derived from the environment (various soil microorganisms) or human. The spoilage can be controlled by the addition of a chemical such as a preservative, but the addition of such a chemical can often cause degradation of the durability of the pressure-sensitive adhesive optical film, which makes difficult the use of it. In an embodiment of the invention, the residual monomer content of the aqueous dispersion pressure-sensitive adhesive (aqueous dispersion) subjected to the applying step (1) is kept at an appropriate level, so that the aqueous dispersion pressure-sensitive adhesive (aqueous dispersion) can be prevented from being spoiled, which can ensure storage stability and further contribute to an improvement in the durability of the pressure-sensitive adhesive layer.

From the above points of view, the residual monomer content of the aqueous dispersion pressure-sensitive adhesive used in the applying step (1) is more preferably from 5,000 to 25,000 ppm, even more preferably from 7,000 to 25,000 ppm, still more preferably from 10,000 to 25,000 ppm.

For example, the residual monomer content of the aqueous dispersion pressure-sensitive adhesive to be used in the applying step (1) can be controlled by controlling the polymerization end point in the polymerization process for preparing the base polymer. For example, when a water-dispersible (meth)acryl-based polymer is prepared in the form of an aqueous dispersion (emulsion) by the emulsion polymerization, the time and temperature of the polymerization can be controlled so that the residual monomer content of the aqueous dispersion pressure-sensitive adhesive can be controlled within the above range. More specifically, the type of the polymerization initiator to be used, the polymerization temperature, and the polymerization time may be controlled taking into account the relationship between them. For example, when a radical-polymerization initiator is used, the degree of polymerization (degree of polymerization conversion) can be controlled taking into account the relationship between the actual polymerization temperature and the 10 hour half-life temperature, which is determined for each initiator. Alternatively, the residual monomer content of the aqueous dispersion pressure-sensitive adhesive may be controlled by adding a redox additive for accelerating the polymerization reaction as described in Patent Document 3 listed above. It should be noted that in the invention, it is important to adjust the residual monomer content of the aqueous dispersion to a level significantly higher than that obtained under the polymerization conditions for a conventional aqueous dispersion pressure-sensitive adhesive. The aqueous dispersion pressure-sensitive adhesive has a relatively high base content and a moderate viscosity. Therefore, the aqueous dispersion obtained after the polymerization may be directly used in the applying step (1).

As used herein, the residual monomer content of the aqueous dispersion pressure-sensitive adhesive refers to the content of the residual monomer or monomers in 1 g of the solid of the aqueous dispersion for the aqueous dispersion pressure-sensitive adhesive. The residual monomer content of the aqueous dispersion for the aqueous dispersion pressure-sensitive adhesive may be quantified by the same method as in the quantification of the residual monomer content of the pressure-sensitive adhesive layer.

The applying step (1) may be performed using any of various methods. Examples include roll coating, kiss roll coating, gravure coating, reverse coating, roll brushing, spray coating, dip roll coating, bar coating, knife coating, air knife coating, curtain coating, lip coating, and extrusion coating with a die coater or the like. The applying step (1) is performed on the optical film in the process (A) and performed on the release film in the process (B).

In the applying step (1), the amount of the application is so controlled that a pressure-sensitive adhesive layer with a desired thickness (post-drying thickness) can be formed. The thickness (post-drying thickness) of the pressure-sensitive adhesive layer is generally set to be from about 1 to about 100 μm, preferably from 5 to 50 μm, more preferably from 10 to 40 μm.

Subsequently, the steps (2A) and (2B) for forming a pressure-sensitive adhesive layer are performed in the processes (A) and (B), respectively. In the forming steps (2A) and (2B), the applied aqueous dispersion pressure-sensitive adhesive is dried at a drying temperature of 80 to 170° C. In an embodiment of the invention, the drying temperature is a particularly important control factor for controlling the residual monomer content of the pressure-sensitive adhesive layer within the specific range. In the step (2A) or (2B) for forming a pressure-sensitive adhesive layer, therefore, the drying temperature is preferably set at the above level so that water and the residual monomer can be effectively volatilized from the aqueous dispersion pressure-sensitive adhesive.

If the drying temperature is less than 80° C., water, the residual monomer, and an ammonia component used for neutralization or the like can be easily left in the pressure-sensitive adhesive layer, so that the pressure-sensitive adhesive layer coating may have insufficient strength, which makes it difficult to ensure durability. On the other hand, if the drying temperature is more than 170° C., the remaining monomer may be subjected to too high-speed drying, and therefore, the residual monomer may be insufficiently effective in accelerating the film formation during the drying, which makes it difficult to obtain a pressure-sensitive adhesive layer with sufficient strength. In addition, the influence of the residual radical polymerization initiator may cause discoloration or thermal damage to the optical film or the release film (for example, oligomer precipitation or the like may occur in a film-based release liner). The drying temperature is preferably from 100 to 140° C. The drying step may also be divided into two or more parts, which are performed under different temperature conditions. For effective volatilization of water and the residual monomer, for example, it is preferred that setting at least two different drying temperatures should be effectively used. It should also be noted that in an embodiment of the invention, the state of the pressure-sensitive adhesive layer coating can be indirectly evaluated by determining the residual monomer content after the step of drying the aqueous dispersion pressure-sensitive adhesive with a specific residual monomer content.

The drying time at the drying temperature is preferably a relatively long time of 10 minutes or more in a hot air circulation oven or the like being simply used, while it may be appropriately determined depending on the drying equipment to be used. In contrast, an oven of a coating facility for use as a production facility has well-designed drying capacity and thermal conductivity, and therefore, using such an oven, the pressure-sensitive adhesive optical film of the invention can be obtained in a relatively short time of about several minutes. It should be noted that a too long drying time may cause oxidative degradation or discoloration of the pressure-sensitive adhesive layer, and therefore the drying time is preferably 60 minutes or less.

The drying conditions including the drying temperature and the drying time may be appropriately determined depending on the drying equipment. For example, when a hot air circulation oven is used, the drying conditions are preferably determined as follows:

when the drying temperature is from 80 to less than 120° C., the drying time is set at 20 to 60 minutes;

when the drying temperature is from 120 to less than 140° C., the drying time is set at 10 to 30 minutes; and

when the drying temperature is from 140 to 170° C., the drying time is set at 10 to 15 minutes.

For example, when an oven of a coating facility is used, the drying conditions are preferably determined as follows:

when the drying temperature is from 80 to less than 120° C., the drying time is set at 5 to 20 minutes;

when the drying temperature is from 120 to less than 140° C., the drying time is set at 2 to 10 minutes; and

when the drying temperature is from 140 to 170° C., the drying time is set at 1 to 5 minutes.

In the process (A), the step (2A) for forming the pressure-sensitive adhesive layer allows direct formation of the pressure-sensitive adhesive layer on an optical film, so that a pressure-sensitive adhesive optical film is obtained. In the process (B), the step (2B) for forming the pressure-sensitive adhesive layer allows formation of the pressure-sensitive adhesive layer on a release film, and then the step (3) of bonding the pressure-sensitive adhesive layer to an optical film is performed so that the pressure-sensitive adhesive layer is transferred to the optical film to form a pressure-sensitive adhesive optical film.

Examples of the material used to form the release film include a plastic film such as a polyethylene, polypropylene, polyethylene terephthalate, or polyester film, a porous material such as paper, fabric, or nonwoven fabric, and an appropriate thin material such as a net, a foamed sheet, a metal foil, and a laminate thereof. A plastic film is preferably used, because of its good surface smoothness.

Any plastic film capable of protecting the pressure-sensitive adhesive layer may be used, examples of which include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, and an ethylene-vinyl acetate copolymer film.

The thickness of the release film is generally from about 5 to about 200 μm, preferably from about 5 to about 100 μm. If necessary, the separator may be subjected to a release treatment and an antifouling treatment with a silicone, fluoride, long-chain alkyl, or fatty acid amide release agent, silica powder or the like, or subjected to an antistatic treatment of coating type, kneading and mixing type, vapor-deposition type, or the like. In particular, when the surface of the release film is appropriately subjected to a release treatment such as a silicone treatment, a long-chain alkyl treatment, or a fluorine treatment, the releasability from the pressure-sensitive adhesive layer can be further increased.

The pressure-sensitive adhesive layer may be exposed. In such a case, the pressure-sensitive adhesive layer may be protected by the release film until it is actually used. The release-treated film may be used as is as a separator for a pressure-sensitive adhesive optical film, so that the process can be simplified.

An optical film may also be coated with an anchor layer or subjected to any adhesion-facilitating treatment such as a corona treatment or a plasma treatment so as to have improved adhesion to a pressure-sensitive adhesive layer, and then the pressure-sensitive adhesive layer may be formed. The surface of the pressure-sensitive adhesive layer may also be subjected to an adhesion-facilitating treatment.

Materials that may be used to form the anchor layer preferably include an anchoring agent selected from polyurethane, polyester, polymers containing an amino group in the molecule, and polymers containing an oxazolinyl group in the molecule, in particular, preferably polymers containing an amino group in the molecule and polymers containing an oxazolinyl group in the molecule. Polymers containing an amino group in the molecule and polymers containing an oxazolinyl group in the molecule allow the amino group in the molecule or an oxazolinyl group in the molecule to react with a carboxyl group or the like in the pressure-sensitive adhesive or to make an interaction such as an ionic interaction, so that good adhesion can be ensured.

Examples of polymers containing an amino group in the molecule include polyethyleneimine, polyallylamine, polyvinylamine, polyvinylpyridine, polyvinylpyrrolidine, and a polymer of an amino group-containing monomer such as dimethylaminoethyl acrylate.

The optical film is, but not limited to the kinds, used for forming image display such as liquid crystal display. A polarizing plate is exemplified. A polarizing plate including a polarizer and a transparent protective film provided on one side or both sides of the polarizer is generally used.

A polarizer is, but not limited to, various kinds of polarizer may be used. As a polarizer, for example, a film that is uniaxially stretched after having dichromatic substances, such as iodine and dichromatic dye, absorbed to hydrophilic polymer films, such as polyvinyl alcohol-based film, partially formalized polyvinyl alcohol-based film, and ethylene-vinyl acetate copolymer-based partially saponified film; polyene-based alignment films, such as dehydrated polyvinyl alcohol and dehydrochlorinated polyvinyl chloride, etc. may be mentioned. In these, a polyvinyl alcohol-based film on which dichromatic materials such as iodine, is absorbed and aligned after stretched is suitably used. Thickness of polarizer is, but not limited to, generally about 5 to about 80 μm.

A polarizer that is uniaxially stretched after a polyvinyl alcohol-based film dyed with iodine is obtained by stretching a polyvinyl alcohol film by 3 to 7 times the original length, after dipped and dyed in aqueous solution of iodine. If needed the film may also be dipped in aqueous solutions, such as boric acid and potassium iodide, which may include zinc sulfate, zinc chloride. Furthermore, before dyeing, the polyvinyl alcohol-based film may be dipped in water and rinsed if needed. By rinsing polyvinyl alcohol-based film with water, effect of preventing un-uniformity, such as unevenness of dyeing, is expected by making polyvinyl alcohol-based film swelled in addition that also soils and blocking inhibitors on the polyvinyl alcohol-based film surface may be washed off. Stretching may be applied after dyed with iodine or may be applied concurrently, or conversely dyeing with iodine may be applied after stretching. Stretching is applicable in aqueous solutions, such as boric acid and potassium iodide, and in water bath.

A thermoplastic resin with a high level of transparency, mechanical strength, thermal stability, moisture blocking properties, isotropy, and the like may be used as a material for forming the transparent protective film. Examples of such a thermoplastic resin include cellulose resins such as triacetylcellulose, polyester resins, polyethersulfone resins, polysulfone resins, polycarbonate resins, polyamide resins, polyimide resins, polyolefin resins, (meth)acrylic resins, cyclic olefin polymer resins (norbornene resins), polyarylate resins, polystyrene resins, polyvinyl alcohol resins, and any mixture thereof. The transparent protective film is generally laminated to one side of the polarizer with the adhesive layer, but thermosetting resins or ultraviolet curing resins such as (meth)acrylic, urethane, acrylic urethane, epoxy, or silicone resins may be used to other side of the polarizer for the transparent protective film. The transparent protective film may also contain at least one type of any appropriate additive. Examples of the additive include an ultraviolet absorbing agent, an antioxidant, a lubricant, a plasticizer, a release agent, an anti-discoloration agent, a flame retardant, a nucleating agent, an antistatic agent, a pigment, and a colorant. The content of the thermoplastic resin in the transparent protective film is preferably from 50 to 100% by weight, more preferably from 50 to 99% by weight, still more preferably from 60 to 98% by weight, particularly preferably from 70 to 97% by weight. If the content of the thermoplastic resin in the transparent protective film is 50% by weight or less, high transparency and other properties inherent in the thermoplastic resin can fail to be sufficiently exhibited.

An optical film of the invention may be exemplified as other optical layers, such as a reflective plate, a transflective plate, a retardation plate (a half wavelength plate and a quarter wavelength plate included), and a viewing angle compensation film, which may be used for formation of a liquid crystal display etc.. These are used in practice as an optical film, or as one layer or two layers or more of optical layers laminated with polarizing plate.

Although an optical film with the above described optical layer laminated to the polarizing plate may be formed by a method in which laminating is separately carried out sequentially in manufacturing process of a liquid crystal display or the like, an optical film in a form of being laminated beforehand has an outstanding advantage that it has excellent stability in quality and assembly workability, and thus manufacturing processes ability of a liquid crystal display or the like may be raised. Proper adhesion means, such as a pressure-sensitive adhesive layer, may be used for laminating. On the occasion of adhesion of the above described polarizing plate and other optical films, the optical axis may be set as a suitable configuration angle according to the target retardation characteristics or the like.

The pressure-sensitive adhesive optical film of the invention is preferably used to form various types of image displays such as liquid crystal displays. Liquid crystal displays may be produced according to conventional techniques.

Specifically, liquid crystal displays are generally produced by appropriately assembling a display panel such as a liquid crystal cell and the pressure-sensitive adhesive optical film and optionally other components such as a lighting system and incorporating a driving circuit according to any conventional technique, except that the pressure-sensitive adhesive optical film of the invention is used. Any type of liquid crystal cell may also be used such as a TN type, an STN type, a n type, a VA type and an IPS type.

Suitable liquid crystal displays, such as liquid crystal display with which the above pressure-sensitive adhesive optical film has been provided on one side or both sides of the display panel such as a liquid crystal cell, and with which a backlight or a reflective plate is used for a lighting system may be manufactured. In this case, the pressure-sensitive adhesive optical film may be provided on one side or both sides of the display panel such as a liquid crystal cell. When providing the pressure-sensitive adhesive optical films on both sides, they may be of the same type or of different type. Furthermore, in assembling a liquid crystal display, suitable parts, such as diffusion plate, anti-glare layer, antireflection film, protective plate, prism array, lens array sheet, optical diffusion plate, and backlight, may be installed in suitable position in one layer or two or more layers.

### EXAMPLES

Hereinafter, the invention is more specifically described with reference to the Examples, which however are not intended to limit the invention. Unless otherwise stated, “parts” and “%” in each example are all by weight.

### <Method for Quantification of Residual Monomer Content>

The residual monomer content of the aqueous dispersion for the aqueous dispersion acryl-based pressure-sensitive adhesive (emulsion) of each example was determined per 1 g of the solid of the adhesive by gas chromatography and liquid chromatography. When any high-boiling-point monomer (with a boiling point of 250° C. or more) is present, the sum of the measurements obtained by liquid chromatography and headspace gas chromatography corresponds to the residual monomer content. The residual monomer content per 1 g of the solid of each pressure-sensitive adhesive layer was also quantified by the same analysis method as the above. In each example, a phosphoric acid ester monomer or a reactive emulsifying agent corresponds to such a high-boiling-point monomer.

### <Gas Chromatography>

After 10 mL of ethyl acetate was added to about 0.2 g of the sample, the mixture was allowed to stand at room temperature (23° C.) for 3 days, so that the monomers were extracted from the pressure-sensitive adhesive (or pressure-sensitive adhesive layer). One pL of the liquid extract was injected into a gas chromatographic analyzer (7890A, manufactured by Agilent Technologies, Inc.) and analyzed.

The measurement conditions were as follows: column, HP-1; column temperature, 40° C. (for 1 minute)→5° C./minute (increase)→60° C.→10° C./minute (increase)→140° C.→20° C./minute (increase)→300° C. (for 5 minutes); detector, FID.

### <Liquid Chromatography>

After 10 mL of ethyl acetate was added to about 0.1 g of the sample, the mixture was allowed to stand at room temperature (23° C.) for 3 days, so that the monomers were extracted from the pressure-sensitive adhesive (or pressure-sensitive adhesive layer), and 40 mL of acetonitrile was further added to the extract to form a solution. Ten μL of the solution was injected into a liquid chromatographic analyzer (CCPM/UV8000, manufactured by TOSOH CORPORATION) and analyzed.

The measurement conditions were as follows: column, Intersil ODS-3; column temperature, 40° C.; detector, UV.

### <Average Particle Size>

The average particle size of the (meth)acryl-based polymer in the aqueous dispersion acryl-based pressure-sensitive adhesive (emulsion) formed using the aqueous dispersion of each example was measured using LS13320 manufactured by Beckman Coulter, Inc.

### Example 1

(Preparation of Aqueous Dispersion acryl-based pressure-sensitive adhesive)

To a vessel were added 1,000 parts of butyl acrylate, 50 parts of acrylic acid, 30 parts of mono[poly(propylene oxide)methacrylate]phosphate ester (5.0 in average degree of polymerization of propylene oxide), and 0.1 parts of 3-methacryloyloxypropyl-triethoxysilane (KBM-503, manufactured by Shin-Etsu Chemical Co., Ltd.) as raw materials and mixed to form a monomer mixture. Subsequently, 13 parts of AQUALON HS-10 (manufactured by Dai-ichi Kogyo Seiyaku Co., Ltd.) as a reactive emulsifying agent and 360 parts of ion-exchanged water were added to 600 parts of the monomer mixture prepared with the above composition, and stirred at 7,000 rpm for 3 minutes using a homogenizer (manufactured by PRIMIX Corporation), so that a monomer emulsion was obtained.

Subsequently, 200 parts of the monomer emulsion prepared as described above and 350 parts of ion-exchanged water were added to a reaction vessel equipped with a condenser tube, a nitrogen-introducing tube, a thermometer, a dropping funnel, and a stirring blade. Subsequently, after the space in the reaction vessel was replaced with nitrogen sufficiently, 0.1 parts of ammonium persulfate was added to the vessel, and polymerization was carried out at 60° C. for 1 hour (initial polymerization). Subsequently, the remaining part of the monomer emulsion was added dropwise to the reaction vessel over 3 hours, and then polymerization was carried out for 3 hours (intermediate polymerization). Subsequently, while the atmosphere was replaced with nitrogen, polymerization was further carried out at 65° C. for 5 hours (final polymerization), so that an aqueous dispersion acryl-based pressure-sensitive adhesive (emulsion) with a solids content of 45% was obtained. Subsequently, after the aqueous dispersion acryl-based pressure-sensitive adhesive was cooled to room temperature, 30 parts of 10% ammonia water was added thereto, and distilled water was further added, so that the solids content was adjusted to 39%. The resulting aqueous dispersion acryl-based pressure-sensitive adhesive had a residual monomer content of 10,300 ppm. The (meth)acryl-based polymer in the aqueous dispersion acryl-based pressure-sensitive adhesive (emulsion) had an average particle size of 0.085 μm.

(Formation of Pressure-Sensitive Adhesive Layer and Preparation of Pressure-Sensitive Adhesive polarizing plate)

The aqueous dispersion acryl-based pressure-sensitive adhesive was applied to a release film (Diafoil MRF-38, manufactured by Mitsubishi Chemical Polyester Co., Ltd., a polyethylene terephthalate backing) with an applicator so that a 25 μm thick coating could be formed after drying, and then the coating was dried at 120° C. for 15 minutes in a hot air circulation oven to form a pressure-sensitive adhesive layer. The pressure-sensitive adhesive layer was bonded to a polarizing plate (SEG-DU (product name) manufactured by NITTO DENKO CORPORATION), so that a pressure-sensitive adhesive polarizing plate was obtained. Before the bonding, the pressure-sensitive adhesive layer had a residual monomer content of 7 ppm.

### Example 2

(Preparation of Aqueous Dispersion acryl-based pressure-sensitive adhesive)

An aqueous dispersion acryl-based pressure-sensitive adhesive was prepared as in Example 1, except that the conditions for the final polymerization were changed to 65° C. for 2 hours in the process of preparing the aqueous dispersion acryl-based pressure-sensitive adhesive (aqueous dispersion (emulsion)). The resulting aqueous dispersion acryl-based pressure-sensitive adhesive had a residual monomer content of 23,500 ppm. The (meth)acryl-based polymer in the aqueous dispersion acryl-based pressure-sensitive adhesive (emulsion) had an average particle size of 0.092 μm.

(Formation of Pressure-Sensitive Adhesive Layer and Preparation of Pressure-Sensitive Adhesive polarizing plate)

A pressure-sensitive adhesive layer was formed as in Example 1, except that the aqueous dispersion acryl-based pressure-sensitive adhesive prepared as described above was used in the formation of the pressure-sensitive adhesive layer and that the drying conditions in the hot air circulation oven were changed to 140° C. for 15 minutes. A pressure-sensitive adhesive polarizing plate was also prepared as in Example 1. Before the bonding, the pressure-sensitive adhesive layer had a residual monomer content of 28 ppm.

### Example 3

(Preparation of Aqueous Dispersion acryl-based pressure-sensitive adhesive)

An aqueous dispersion acryl-based pressure-sensitive adhesive was prepared as in Example 1, except that the conditions for the final polymerization were changed to 75° C. for 5 hours in the process of preparing the aqueous dispersion acryl-based pressure-sensitive adhesive (aqueous dispersion (emulsion)). The resulting aqueous dispersion acryl-based pressure-sensitive adhesive had a residual monomer content of 5,100 ppm. The (meth)acryl-based polymer in the aqueous dispersion acryl-based pressure-sensitive adhesive (emulsion) had an average particle size of 0.088 μm.

(Formation of Pressure-Sensitive Adhesive Layer and Preparation of Pressure-Sensitive Adhesive polarizing plate)

A pressure-sensitive adhesive layer was formed as in Example 1, except that the aqueous dispersion acryl-based pressure-sensitive adhesive prepared as described above was used in the formation of the pressure-sensitive adhesive layer and that the drying conditions in the hot air circulation oven were changed to 100° C. for 30 minutes. A pressure-sensitive adhesive polarizing plate was also prepared as in Example 1. Before the bonding, the pressure-sensitive adhesive layer had a residual monomer content of 48 ppm.

### Example 4

(Formation of Pressure-Sensitive Adhesive Layer and Preparation of Pressure-Sensitive Adhesive polarizing plate)

A pressure-sensitive adhesive layer was formed as in Example 1, except that the aqueous dispersion acryl-based pressure-sensitive adhesive prepared in Example 3 was used in the formation of the pressure-sensitive adhesive layer and that the drying conditions in the hot air circulation oven were changed to 80° C. for 40 minutes. A pressure-sensitive adhesive polarizing plate was also prepared as in Example 1. Before the bonding, the pressure-sensitive adhesive layer had a residual monomer content of 80 ppm.

### Example 5

(Formation of Pressure-Sensitive Adhesive Layer and Preparation of Pressure-Sensitive Adhesive polarizing plate)

The aqueous dispersion acryl-based pressure-sensitive adhesive prepared in Example 1 was continuously applied to a release film (Diafoil MRF-38, manufactured by Mitsubishi Chemical Polyester Co., Ltd., a polyethylene terephthalate backing) by a comma coater method so that a 25 μm thick coating could be formed after drying, and then the coating was continuously dried using an experimental coating machine oven, so that a pressure-sensitive adhesive layer was formed. In the experimental coating machine oven, the drying was performed in the following two stages: 120° C. for 1 minute and 130° C. for 2 minutes. The pressure-sensitive adhesive layer was bonded to a polarizing plate (SEG-DU (product name) manufactured by NITTO DENKO CORPORATION), so that a pressure-sensitive adhesive polarizing plate was obtained. Before the bonding, the pressure-sensitive adhesive layer had a residual monomer content of 10 ppm.

### Comparative Example 1

(Formation of Pressure-Sensitive Adhesive Layer and Preparation of Pressure-Sensitive Adhesive polarizing plate)

A pressure-sensitive adhesive layer was formed as in Example 1, except that, in the formation of the pressure-sensitive adhesive layer, the drying conditions in the hot air circulation oven were changed to 100° C. for 2 minutes. A pressure-sensitive adhesive polarizing plate was also prepared as in Example 1. Before the bonding, the pressure-sensitive adhesive layer had a residual monomer content of 250 ppm.

### Comparative Example 2

(Formation of Pressure-Sensitive Adhesive Layer and Preparation of Pressure-Sensitive Adhesive polarizing plate)

A pressure-sensitive adhesive layer was formed as in Example 1, except that, in the formation of the pressure-sensitive adhesive layer, the drying conditions in the hot air circulation oven were changed to 180° C. for 10 minutes. A pressure-sensitive adhesive polarizing plate was also prepared as in Example 1. Before the bonding, the pressure-sensitive adhesive layer had a residual monomer content of 2 ppm. The slightly brown pressure-sensitive adhesive layer was obtained.

### Comparative Example 3

(Preparation of Aqueous Dispersion acryl-based pressure-sensitive adhesive)

An aqueous dispersion acryl-based pressure-sensitive adhesive was prepared as in Example 1, except that the final polymerization was not performed in the process of preparing the aqueous dispersion acryl-based pressure-sensitive adhesive (aqueous dispersion (emulsion)). The aqueous dispersion acryl-based pressure-sensitive adhesive had a residual monomer content of 28,000 ppm. The (meth)acryl-based polymer in the aqueous dispersion acryl-based pressure-sensitive adhesive (emulsion) had an average particle size of 0.085 μm.

(Formation of Pressure-Sensitive Adhesive Layer and Preparation of Pressure-Sensitive Adhesive polarizing plate)

A pressure-sensitive adhesive layer was formed as in Example 1, except that the aqueous dispersion acryl-based pressure-sensitive adhesive prepared as described above was used in the formation of the pressure-sensitive adhesive layer and that the drying conditions in the hot air circulation oven were changed to 150° C. for 3 minutes. A pressure-sensitive adhesive polarizing plate was also prepared as in Example 1. Before the bonding, the pressure-sensitive adhesive layer had a residual monomer content of 120 ppm.

### Comparative Example 4

(Preparation of Aqueous Dispersion acryl-based pressure-sensitive adhesive)

After the final polymerization in the process of Example 1, 0.3 parts of 30% hydrogen peroxide water and 0.6 parts of ascorbic acid were added to 100 parts (solid basis) of the obtained aqueous dispersion acryl-based pressure-sensitive adhesive (aqueous dispersion (emulsion)) with a solids content of 45%, and the mixture was heated at 75° C. for 3 hours. Subsequently, after the aqueous dispersion acryl-based pressure-sensitive adhesive was cooled to room temperature, 30 parts of 10% ammonia water was added thereto, and distilled water was further added, so that the solids content was adjusted to 39%. The resulting aqueous dispersion acryl-based pressure-sensitive adhesive had a residual monomer content of 1,200 ppm. The (meth)acryl-based polymer in the aqueous dispersion acryl-based pressure-sensitive adhesive (emulsion) had an average particle size of 0.082 μm.

(Formation of Pressure-Sensitive Adhesive Layer and Preparation of Pressure-Sensitive Adhesive polarizing plate)

A pressure-sensitive adhesive layer was formed as in Example 1, except that the aqueous dispersion acryl-based pressure-sensitive adhesive prepared as described above was used in the formation of the pressure-sensitive adhesive layer and that the drying conditions in the hot air circulation oven were changed to 140° C. for 15 minutes. A pressure-sensitive adhesive polarizing plate was also prepared as in Example 1. Before the bonding, the pressure-sensitive adhesive layer had a residual monomer content of 4 ppm.

The pressure-sensitive adhesive polarizing plate obtained in each of the examples and the comparative examples was evaluated as described below. The results of the evaluation are shown in Table 1.

[Evaluation of the Durability of Pressure-sensitive adhesive optical film]

The pressure-sensitive adhesive polarizing plate of each of the examples and the comparative examples was cut into a piece with a size of 235 mm×310 mm, which was bonded to a 0.7 mm thick glass plate (Corning #1737, manufactured by Corning Incorporated) and allowed to stand for 15 minutes in an autoclave at 50° C. and 0.5 MPa. Subsequently, it was heated in an atmosphere at 80° C. for 500 hours (heating) and in an atmosphere at 60° C/90%RH for 500 hours (humidification), respectively, and then the presence or absence of foaming and peeling in the pressure-sensitive adhesive polarizing plate was checked by visual observation using a loupe. The presence or absence of peeling in the pressure-sensitive adhesive polarizing plate was checked and evaluated according to the criteria below.

<Durability against Heating>
4: Bubbles of 100 pm or more were not observed per 1 cm².
3: 1 to 5 bubbles of 100 pm or more were observed per 1 cm².
2: 6 to 10 bubbles of 100 pm or more were observed per 1 cm².
1: 11 or more bubbles of 100 pm or more were observed per 1 cm².
<Durability against Humidification>
4: No peeling occurred at the end of the pressure-sensitive adhesive polarizing plate.
3: Peeling occurred from the end of the pressure-sensitive adhesive polarizing plate to a site within 0.1 mm from the end.
2: Peeling occurred from the end of the pressure-sensitive adhesive polarizing plate to a site within more than 0.1 mm to 1 mm from the end.
1: Peeling occurred from the end of the pressure-sensitive adhesive polarizing plate to a site within more than 1 mm from the end.

### [Polymer Liquid Spoilage Test]

An empty mayonnaise bottle with a volume of 900 mL was allowed to stand for about one week while it was opened. Subsequently, 850 g of the aqueous dispersion acryl-based pressure-sensitive adhesive (the emulsion whose residual monomer content had been measured) of each of the examples and the comparative examples was added to the bottle, and the bottle was tightly capped. The bottle was then stored in a dark and cool place at room temperature for 3 months, and subsequently whether or not the pressure-sensitive adhesive was spoiled was determined from the viewpoint of color and odor according to the criteria below.

ο: There was no difference in color or odor from the initial state.
x: Rotten brown matter was observed floating in the upper part of the liquid, and a sour odor was present.

TABLE 1

| | Aqueous dispersion | | | Pressure-sensitive | | | |
|---|---|---|---|---|---|---|---|
| | Residual | Average particle | | adhesive layer | Evaluation | | |
| | monomer | size (μm) of | | Residual monomer | Durability | | |
| | content | (meth) acryl-based | Drying conditions | content | | 60° C./ | Spoilage |
| | (ppm) | polymer | Temperature × time | (ppm) | 80° C. | 90% RH | test |
| Example 1 | 10300 | 0.085 | 120° C. × 15 minutes | 7 | 4 | 4 | ◯ |
| Example 2 | 23500 | 0.092 | 140° C. × 15 minutes | 28 | 4 | 3 | ◯ |
| Example 3 | 5100 | 0.088 | 100° C. × 30 minutes | 48 | 3 | 3 | ◯ |
| Example 4 | 5100 | 0.088 | 80° C. × 40 minutes | 80 | 3 | 2 | ◯ |
| Example 5 | 10300 | 0.085 | 120° C. × 1 minute + | 10 | 4 | 4 | ◯ |
| | | | 130° C. × 2 minutes | | | | |
| Comparative | 10300 | 0.085 | 100° C. × 2 minutes | 250 | 1 | 1 | ◯ |
| Example 1 | | | | | | | |
| Comparative | 10300 | 0.085 | 180° C. × 10 minutes | 2 | 3 | 1 | ◯ |
| Example 2 | | | | | | | |
| Comparative | 28000 | 0.085 | 150° C. × 3 minutes | 120 | 1 | 2 | ◯ |
| Example 3 | | | | | | | |
| Comparative | 1200 | 0.082 | 140° C. × 15 minutes | 4 | 3 | 1 | X |
| Example 4 | | | | | | | |

1. A pressure-sensitive adhesive layer for an optical film, which is formed by applying an aqueous dispersion pressure-sensitive adhesive comprising an aqueous dispersion containing at least a base polymer dispersed in water, and then drying the applied aqueous dispersion pressure-sensitive adhesive, wherein
a content of residual monomer in the pressure-sensitive adhesive layer is 5 to 100 ppm per 1 g of the solid of the pressure-sensitive adhesive layer.

2. The pressure-sensitive adhesive layer for an optical film according to claim 1, wherein the base polymer in the aqueous dispersion pressure-sensitive adhesive is a (meth)acryl-based polymer.

3. The pressure-sensitive adhesive layer for an optical film according to claim 1, wherein the base polymer is a (meth)acryl-based polymer obtained by emulsion polymerization.

4. A pressure-sensitive adhesive optical film, comprising an optical film and the pressure-sensitive adhesive layer for an optical film according to claim 1 placed on at least one side of the optical film.

5. A method for manufacturing the pressure-sensitive adhesive optical film according to claim 4, comprising the steps of:
(1) applying an aqueous dispersion pressure-sensitive adhesive to one or both sides of an optical film, wherein the aqueous dispersion pressure-sensitive adhesive comprises an aqueous dispersion containing at least a base polymer dispersed in water and has a residual monomer content of 1,500 to 25,000 ppm per 1 g of the solid of the aqueous dispersion; and
(2A) drying the applied aqueous dispersion pressure-sensitive adhesive at a drying temperature of 80 to 170° C. so that a pressure-sensitive adhesive layer can be formed having a residual monomer content of 5 to 100 ppm per 1 g of the solid of the pressure-sensitive adhesive layer.

6. A method for manufacturing the pressure-sensitive adhesive optical film according to claim 4, comprising the steps of:
(1) applying an aqueous dispersion pressure-sensitive adhesive to one or both sides of a release film, wherein the aqueous dispersion pressure-sensitive adhesive comprises an aqueous dispersion containing at least a base polymer dispersed in water and has a residual monomer content of 1,500 to 25,000 ppm per 1 g of the solid of the aqueous dispersion;
(2B) drying the applied aqueous dispersion pressure-sensitive adhesive at a drying temperature of 80 to 170° C. so that a pressure-sensitive adhesive layer can be formed having a residual monomer content of 5 to 100 ppm per 1 g of the solid of the pressure-sensitive adhesive layer; and
(3) bonding the pressure-sensitive adhesive layer, which is formed on the release film, to an optical film.

7. An image display comprising at least one piece of the pressure-sensitive adhesive optical film according to claim 4.
